(19) United States
(12) Patent Application Publication
(10) Pub. No.: US 2020/0288747 A1
(43) Pub. Date: Sep. 17, 2020

(54) SYSTEMS AND METHODS FOR AUTOMATICALLY CONTROLLING BRIX WHILE FILLING FROZEN CARBONATED BEVERAGE SYSTEMS

(71) Applicant: Cornelius, Inc., Osseo, MN (US)

(72) Inventors: Jacob C. Greenberg, Elgin, IL (US); Tomasz K. Kasprzycki, Carpentersville, IL (US); Zachary Dresser, Batavia, IL (US)

(73) Assignee: Cornelius, Inc., Osseo, MN (US)

(21) Appl. No.: 16/814,616

(22) Filed: Mar. 10, 2020

Related U.S. Application Data
(60) Provisional application No. 62/819,019, filed on Mar. 15, 2019.
(60) Provisional application No. 62/832,072, filed on Apr. 10, 2019.

(51) Int. Cl. A23G 9/28; A23G 9/04; A23G 9/20

(52) U.S. Cl. CPC A23G 9/283; A23G 9/20; A23G 9/045

(57) ABSTRACT

A method for filling a barrel of a frozen beverage dispenser to create a beverage. The method includes determining a target brix level for the beverage, determining a starting fill setting for a supply line that fills the barrel, and detecting a current condition within at least one of the supply line and the barrel. The method further includes calculating an adjusted fill setting by adjusting the starting fill setting for the supply line based on the current condition detected, and operating the supply line at the adjusted fill setting to fill the barrel such that the target brix level is achieved within the barrel.

### CROSS REFERENCE TO RELATED APPLICATIONS

This application claims the benefit of U.S. Provisional Patent Application No. 62/819,019, filed Mar. 15, 2019 and U.S. Provisional Patent Application No. 62/832,072, filed Apr. 10, 2019, which are incorporated herein by reference in their entirety.

### FIELD

The present disclosure generally relates to frozen carbonated beverage systems, and more particularly to systems and methods for automatically controlling brix while filling frozen carbonated beverage systems.

### BACKGROUND

The Background and Summary are provided to introduce a foundation and selection of concepts that are further described below in the Detailed Description. The Background and Summary are not intended to identify key or essential features of the potentially claimed subject matter, nor are they intended to be used as an aid in limiting the scope of the potentially claimed subject matter.

The following U.S. Patents and Patent Applications are incorporated herein by reference:

U.S. Pat. No. 5,103,649 discloses improvements in the electronic control of frozen carbonated beverage machines and defrost heaters therein. A control scheme is shown that provides for accurately determining the viscosity of a semi-frozen beverage as a function of the torque of a drive motor. The viscosity scale has a zero value when the beverage is known to be completely liquid. Viscosity is maintained within a narrow range based upon pre-defined three level low, medium and high viscosity sets, and wherein compressor short-cycling is eliminated.

U.S. Pat. No. 6,220,047 discloses a dual purpose carbonator/blending bottle connected to a source of beverage syrup, a source of potable water and to a source of pressurized carbon dioxide gas. The dual purpose bottle is retained within an ice bank water bath tank. A pair of ratio valves provide for metering the water and syrup at a desired ratio. A refrigeration system provides for cooling an evaporator located in the water tank for forming the ice bank thereon. The carbonated beverage then flows from the bottle into a freeze cylinder. A scraping mechanism within the cylinder provides for scraping frozen beverage from the inner surface of the cylinder. A control mechanism provides for controlling the refrigeration system and the cooling of both evaporators.

U.S. Pat. No. 6,830,239 discloses a carbonator tank that includes a liquid inlet, a gas inlet and a liquid outlet. A liquid level sensor includes a liquid level sensing portion extending along and within the interior of the carbonator and provides for determining a full and minimal liquid level therein. The liquid then flows into the carbonator interior and contacts a deflection plate and is deflected thereby so that such liquid flow does not disrupt the operation of the level sensing portion of the level sensor.

U.S. Pat. No. 4,728,005 discloses in connection with a beverage dispensing machine, an automatic self-fill control apparatus for the machine for controlling the filling of the liquid tank, which liquid tank is fed with a combination of water and a concentrate syrup adapted to be mixed with the water within the tank. A sensor member is disposed in the tank in a position so as to be responsive to the rise and fall of liquid in the tank. Pump means are provided adapted to pump the syrup to the tank. Control of water flow to the tank is also carried out. The sensor member has a low probe for detecting a low predetermined level of liquid in the tank and a high probe for detecting a high predetermined level of liquid in the tank and adapted to respectively generate low and high probe signals. Control circuit means is provided receiving and responsive to these low and high probe signals for controlling the pump to operate when the low probe is uncovered and terminating the pumping action when the liquid level reaches the high probe position so that the liquid level in the tank is always maintained at a level between the low and high probes. Also provided is a third sensor for determining an unsafe condition referred to herein as a system override to shut the system down in the event that the high probe is covered and that the liquid level proceeds to the even higher third probe. Also in the system is provided a sensor for detecting an out-of-syrup condition.

U.S. Pat. No. 6,705,489 discloses a valve providing for the dispensing of two liquids at a desired ratio. The valve includes first and second liquid flow body assemblies releasably securable to a nozzle body assembly. Each liquid flow body assembly is securable to a source of liquid and includes flow sensing means and flow regulating means. A control receives inputs from the flow sensing means and regulates the operation of the flow regulating means to provide for the dispensing of the two liquids from the nozzle body assembly at a predetermined ratio.

U.S. Pat. No. 7,290,680 discloses a post-mix beverage valve provides for automatic, accurate beverage ratioing. A valve body can be assembled, and includes a water flow hard body, syrup body and common nozzle body. The water and syrup flow bodies define flow channels and include one end for connection to water and syrup respectively, and opposite ends for fluid connection to the nozzle body. The water flow channel includes a turbine flow sensor connected to a micro-controller determining the water flow rate. The syrup flow channel includes a flow sensor, two MEMS pressure sensors, monitoring the syrup. The sensors are connected to the micro-controller and positioned about an orifice and senses sense a differential pressure indicative of syrup flow rate solenoid regulates flow of syrup through the syrup body. A stepper motor on the water body controls a rod in the flow channel in conjunction with a V-groove.

U.S. Pat. No. 9,517,441 discloses systems and methods of beverage dispensing include a dispensing unit, at least one diluent source, and at least one flavoring source. An amount of beverage product to dispense is calculated and a beverage product including at least one diluent and at least one flavoring is dispensed. An actual diluent-to-flavoring ratio is calculated based upon at least one value from the sensing unit during the dispense of the beverage product.

U.S. Patent Application Publication No. 2008/0073376 discloses a dispenser, preferably for a Frozen Carbonate Beverage (FCB) product, having valves that can be manually or electrically operated in response to electronic controls. The valve has a jam dispensing position, and can be used with an additive, such as flavors, injector. A power failure back up is provided to close the valve, along with sanitation and optional purging cycles. Product dispense is provided only when sensed to have a desired consistency and/or in a condition to prevent splashing. Additive dispense is provided only when product is present. The dispenser can have a monitor and suitable controller to dispense strips or layers of different additives or flavors into the product.

U.S. Pat. No. RE 35,780 discloses a post-mix beverage dispensing valve for accurately maintaining the proper ratio of two liquid beverage components. The invention includes a valve main body having a gear pump secured thereto. The gear pump includes two sets of oval gears. One set of oval gears is in fluid communication with a source of pressurized carbonated water, and the second set is in fluid communication with a source of syrup. The valve body also includes solenoid operated pallet valves for each of the beverage components. Ratioing of the solenoid provides for simultaneous opening of both pallet valves whereby the pressurized carbonated water flows between the carbonated water gears and is swept thereby through the valve body to the dispensing nozzle. One gear of each gear pair is secured to a common rotating shaft. Pressurized carbonated water provides for the rotation of the syrup gears, thereby providing for the pumping of the syrup to the nozzle. The gear pairs are sized so that the desired ratio between the beverage components is maintained.

U.S. Pat. No. 8,893,926 discloses an apparatus for and method of cleaning and sanitizing a beverage dispenser is characterized by fluid connectors that may quickly and conveniently be manually fluid coupled with either supplies of beverage components to be delivered through flow paths to beverage dispensing valves or with a source of cleaning and sanitizing fluid to be delivered through the flow paths to the beverage dispensing valves to clean and sanitize the flow paths and dispensing valves. The beverage component supplies have valves with which the fluid connectors fluid couple, and a manifold has an inlet port for receiving cleaning and sanitizing fluid and outlet ports that are each located in proximity to an associated beverage component supply valve and with which the fluid connectors may be fluid coupled after being de-coupled from their associated beverage component supply valves.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One embodiment of the present disclosure generally relates to a method for filling a barrel of a frozen beverage dispenser to create a beverage. The method includes determining a target brix level for the beverage, determining a starting fill setting for a supply line that fills the barrel, and detecting a current condition within at least one of the supply line and the barrel. The method further includes calculating an adjusted fill setting by adjusting the starting fill setting for the supply line based on the current condition detected, and operating the supply line at the adjusted fill setting to fill the barrel such that the target brix level is achieved within the barrel.

Another embodiment generally relates to a frozen beverage dispenser having a barrel configured to be filled with a beverage. The frozen beverage dispenser includes a concentrate supply line controllable by a concentrate valve to fill the barrel with a concentrate. A base supply line is controllable by a base valve to fill the barrel with a base liquid. A target brix level is provided for the beverage in the barrel. Starting fill settings for operating the concentrate valve and the base valve are provided. One or more sensors that detect a current condition within at least one of the concentrate supply line, the base supply line, and the barrel. A control system receives the current condition and calculates an adjusted fill setting for operating at least one of the concentrate valve and the base valve based on the current condition detected. The at least one of the concentrated valve and the base valve are operated according to the adjusted fill setting to fill the barrel such that the target brix level is achieved within the barrel.

Another embodiment generally relates to a method for filling a barrel of a frozen carbonated beverage dispenser to create a beverage. The method includes determining a target brix level for the beverage, and determining starting fill settings for supply lines that fill the barrel, where the supply lines include a concentrate supply line, a carbonation supply line, and a base supply line that fill the barrel via a concentrate valve, carbonation valve, and a base valve, respectively. The method further includes detecting current conditions within each of the supply lines and the barrel, where the current conditions include a pressure and a temperature. The method further includes calculating one or more adjusted fill settings by adjusting one or more of the starting fill settings, based on the current conditions detected and using a lookup table, and operating the supply lines at the base fill settings and the one or more adjusted fill settings, respectively, to fill the barrel such that the target brix level is achieved within the barrel.

Various other features, objects and advantages of the disclosure will be made apparent from the following description taken together with the drawings.

### BRIEF DESCRIPTION OF THE DRAWINGS

The drawings illustrate embodiments for carrying out the disclosure. The same numbers are used throughout the drawings to reference like features and like components. In the drawings:

FIG. 1 is a sectional side view of an exemplary frozen carbonated beverage system according to the present disclosure;

FIGS. 2 and 3 depict schematic views of exemplary beverage production and refrigeration systems for frozen carbonated beverage systems according to the present disclosure, respectively;

FIG. 4 depicts an exemplary process flow for filling a frozen carbonated beverage system according to the present disclosure;

FIG. 5 depicts an exemplary process flow for refrigerating a frozen carbonated beverage system according to the present disclosure;

FIG. 6 depicts an exemplary control system for operating a frozen carbonated beverage system according to the present disclosure;

FIG. 7A is a schematic representation of one embodiment of a system for automatically controlling brix according to the present disclosure;

FIG. 7B is an exemplary process flow for a method corresponding to the system shown in FIG. 7A;

FIG. 8A is a schematic representation of another embodiment of a system for automatically controlling brix according to the present disclosure;

FIG. 8B is an exemplary process flow for a method corresponding to the system shown in FIG. 8A;

FIG. 9A is a schematic representation of another embodiment of a system for automatically controlling brix according to the present disclosure;

FIG. 9B is an exemplary process flow for a method corresponding to the system shown in FIG. 9A;

FIG. 10A is a schematic representation of another embodiment of a system for automatically controlling brix according to the present disclosure;

FIG. 10B is an exemplary process flow for a method corresponding to the system shown in FIG. 10A;

FIG. 11 is a side view of an exemplary selectable orifice device such as would be used within the system of FIG. 10A;

FIG. 12 is a front view of an exemplary selection dial such as would be incorporated within the selectable orifice device shown in FIG. 11;

FIG. 13 depicts an exemplary process flow for filling a frozen carbonated beverage system according to the present disclosure;

FIG. 14 depicts a further embodiment of a process flow for filling a frozen carbonated beverage system according to the present disclosure;

FIG. 15 is an exemplary process flow for detecting beverage dispensing according to the present disclosure;

FIG. 16 depicts an exemplary process for calculating starting fill settings for operating valves to achieve a target brix according to the present disclosure;

FIG. 17 depicts an exemplary method for filling the barrel using the starting fill settings and adjustments thereto, as the case may be, to achieve a target brix in the barrel;

FIG. 18 depicts another exemplary method for filling the barrel using the starting fill settings and adjustments thereto, as the case may be, to achieve a target brix in the barrel; and

FIG. 19 depicts a residual water level within the barrel following a cleaning and sanitation cycle, as may be accounted for by the presently disclosed systems and methods.

### DETAILED DISCLOSURE

This written description uses examples to disclose embodiments of the present disclosure and also to enable any person skilled in the art to practice or make and use the same. The patentable scope of the invention is defined by the potential claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

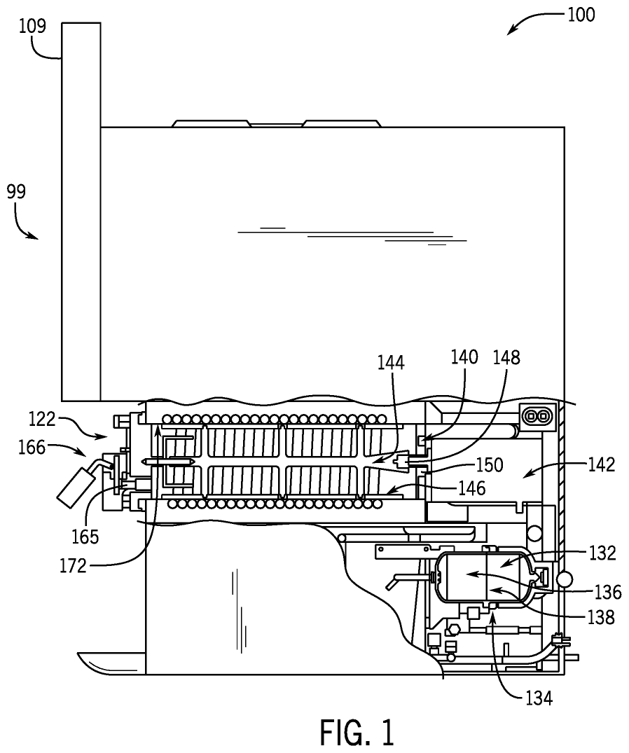

The present disclosure generally relates to systems and methods for dispensing frozen carbonated beverages (FCBs), such as may be offered at a food or beverage service provider, a convenience store, or the like. An exemplary system 100 for producing and dispensing FCBs according to the present disclosure is shown in FIGS. 1-3. FIG. 1 shows an exemplary dispensing machine 99, which prepares and stores a beverage within a barrel 122 until the beverage is dispensed via an outlet 165 and a dispense valve 166. In certain examples, selections for the beverage to be dispensed are made using a user interface 109.

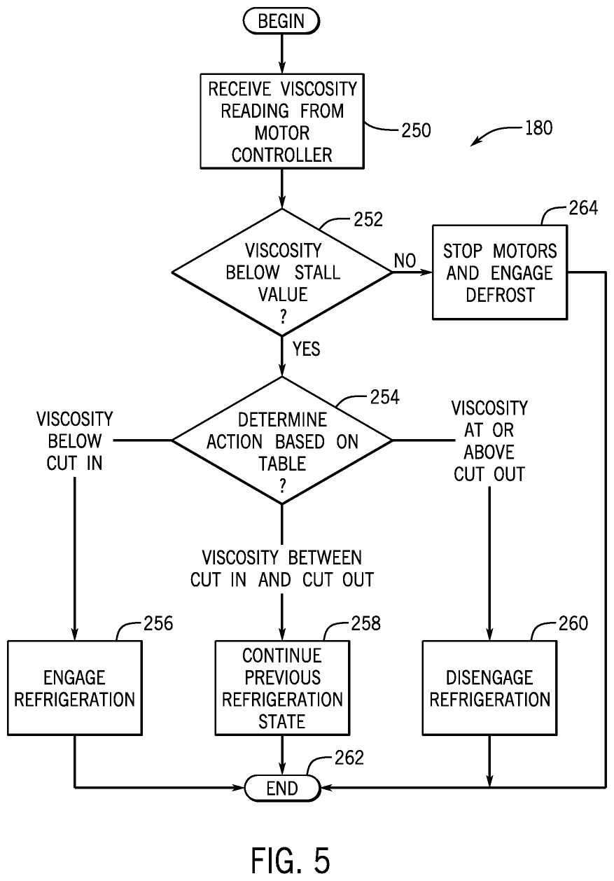

A motor 142 rotates a beater bar 144 and scraper blades 146 attached thereto. In systems 100 known in the art, the beater bar 144 is rotated at a fixed speed (e.g., at 168 RPM). The motor 142 is coupled to the beater bar 144 via a motor coupling shaft 148 that passes through a rotary barrel seal 150. An expansion tank is also provided between supply lines 107 and a barrel inlet 140 defined within the barrel 122. The power required for the motor 142 to rotate the beater bar 144 and the scraper blades 146 through the mixture contained within the barrel 122 is monitored by a control system (FIG. 6, discussed below) having a processing system 610 and memory system 630. This power consumption is then used to estimate the viscosity of product within the barrel 122.

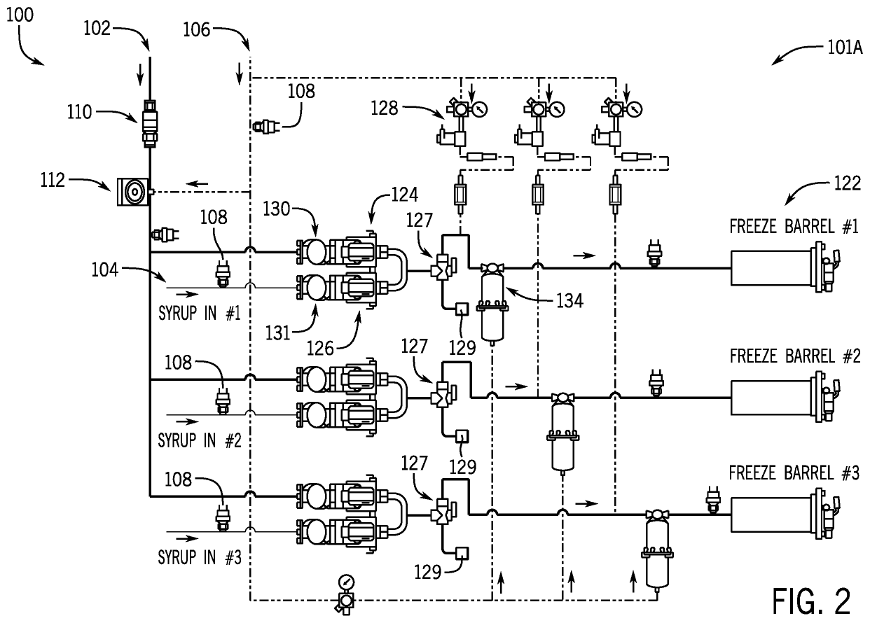

The system 100 includes a beverage production system 101A (FIG. 2) and a refrigeration system 101B (FIG. 3). In the beverage production system 101A of FIG. 2, pressurized water 102 (also referred to as the base supply line), syrup concentrate 104 (also referred to as the concentrate supply line), and CO2 106 (collectively, supply lines 107) are supplied to the system 100. It should be recognized that refers to water, syrup concentrate, and CO2 are synonymous with a water supply line, concentrate supply line, and/or CO2 supply line, respectively, and/or the like. Moreover, the supply lines 107 may include any number of syrup concentrates 104, and/or gasification lines in addition or as an alternative to the CO2 106, such as an NO2 supply, for example. For the sake of clarity, all references to concentrate supply lines will generally be referred to in singular form, and CO2 used to describe all forms of gasification.

Pressures are monitored by “sold out” pressure switches 108 connected to each of the supply lines 107. The pressure of the water 102 entering the system 100 is controlled by reducing the pressure through a regulator 110, then increasing the pressure with a CO2 powered pump 112 to yield a consistent and known final pressure. The pressure provided by this CO2 powered pump 112 is a function of inlet CO2 pressure.

In a similar manner, pressure for the syrup concentrate 104 is supplied by a CO2 powered pump 114, whereby pressure is again provided as a function of inlet CO2 pressure as controlled by a regulator. The resulting pressure of syrup concentrate 104 at the dispensing machine 99 (FIG. 1) is a function of the pressure provided by the CO2 powered pump 114, the distance in elevation between the pump 114 and the dispensing machine 99, tubing diameters for the supply lines 107, syrup concentrate 104 viscosity, the number of splices or joints in the supply lines 107, and other factors.

Continuing with FIG. 2, the pressure of incoming CO2 106 is controlled by a regulator, which for certain systems 100 is set at 75 psig. Supply pressures may drop for multiple reasons. Since all supply lines 107 may incorporate the use of CO2 106 as described above (e.g., via CO2 powered pumps 112 and 114), a reduction in CO2 106 supply pressure can affect all supply lines 107. This can occur when the contents of the CO2 106 tank are depleted, when there is an increased draw on the CO2 106 tank from other dispensing machines 99 or other devices sharing common CO2 106, and/or an increased draw from a single dispensing machines 99, such as if multiple barrels 122 are filled simultaneously as part of a standard maintenance activity, for example.

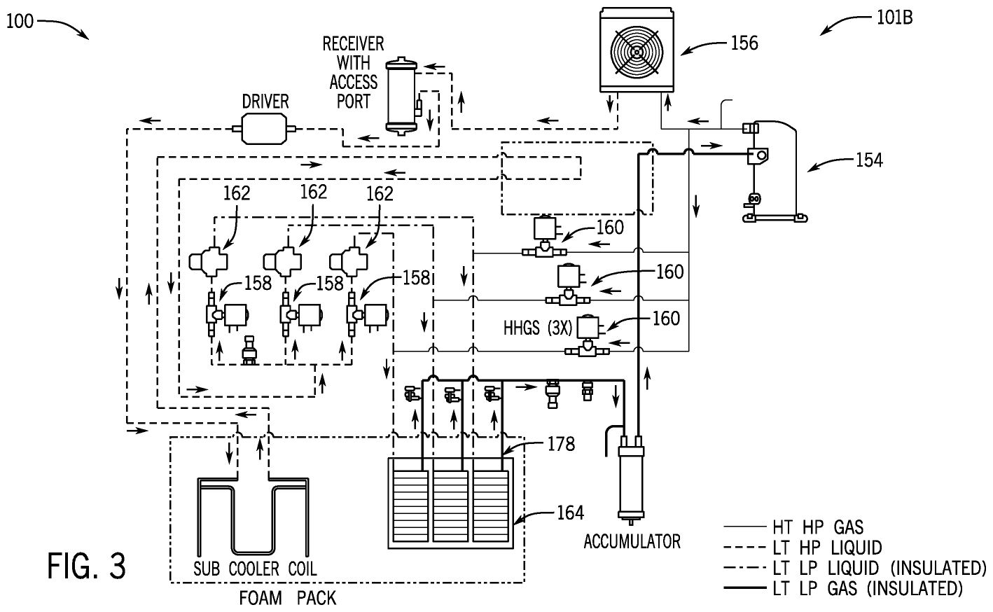

When one of the supply lines 107 is depleted, the pressure of that supply line 107 will drop below a “cut off” pressure as read by a pressure switch 108. A control system 600 (FIG. 6) receives inputs from the pressure switch 108 and compares these pressure values to “cut in” and “cut off” values. If the pressure is below the “cut off” pressure, the control system determines that the supply is “sold out.” The control system 600 then signals the need for the supply to be replenished until the supply pressure is determined to be above a “cut in” pressure as read by the pressure switch 108. When the control system 600 determines that the pressure of the supply line 107 has surpassed the cut in pressure, the control system will no longer indicate that the supply line 107 is “sold out.” An exemplary fill process 168A for this beverage production system 101A (FIG. 2) is shown in FIG. 4, which is discussed further below.

FIG. 6 depicts an exemplary control system 600 for operating a system 100 according to the present disclosure. The control system 600 communicates with input devices 602 (which may include pressure switches 108, for example), output devices 604 (such as the water valves 124), and/or a cloud 606 based network. In the exemplary control system 600 shown, an input/output (I/O) system 620 provides communication between the control system 600 and the input devices 602, output devices 604, and cloud 606, which may each be bidirectional in nature. A processing system 610 within the control system 600 is configured to execute information received from the I/O system 620 and also from the memory system 630. In the example shown, the memory system 630 includes an executable program 632 for operating the control system 600 and the system 100 more generally, as well as a data 634 module for storing such parameters as cut in and cut off pressures, for example within a lookup table 635. Additionally or alternatively, one or more algorithms may be stored within the data 634 for calculating these and other parameters rather than utilizing a lookup table, for example. Exemplary parameters include pressure, temperature, time limits, other physical measures, and/or any thresholds relating thereto.

It should be recognized that certain aspects of the present disclosure are described and depicted, including within FIG. 6, in terms of functional and/or logical block components and various processing steps. It should be recognized that any such functional and/or block components and processing steps may be realized by any number of hardware, software, and/or firmware components configured to perform the specified functions. For example, certain embodiments employ various integrated circuit components, such as memory elements, digital signal processing elements, logic elements, lookup tables, or the like, which are configured to carry out a variety of functions under the control of one or more processors or other control devices. The connections between functional and logical block components are also merely exemplary. Moreover, the present disclosure anticipates communication among and between such components being wired, wireless, and through different pathways

These functions may also include the use of computer programs that include processor-executable instructions, which may be stored on a non-transitory tangible computer readable medium. The computer programs may also include stored data. Non-limiting examples of the non-transitory tangible computer readable medium are nonvolatile memory, magnetic storage, and optical storage. As used herein, the term module may refer to, be part of, or include an application-specific integrated circuit (ASIC), an electronic circuit, a combinational logic circuit, a field programmable gate array (FPGA), a processor system (shared, dedicated, or group) that executes code, or other suitable components that provide the described functionality, or a combination of some or all of the above, such as in a system-on-chip. The term module may include memory (shared, dedicated, or group) that stores code executed by the processor. The term code, as used herein, may include software, firmware, and/or microcode, and may refer to programs, routines, functions, classes, and/or objects. The term shared, as used above, means that some or all code from multiple modules may be executed using a single (shared) processor. In addition, some or all code to be executed by multiple different processors as a computer system may be stored by a single (shared) memory. The term group, as used above, means that some or all code comprising part of a single module may be executed using a group of processors. Likewise, some or all code comprising a single module may be stored using a group of memories as a memory system.

Furthermore, certain elements are shown as singular devices for the sake of clarity, but may be combined or subdivided differently to perform the same function. For example, the processing system 610 may represent a single microprocessor, or a group of microprocessors functioning as a system. This also applies to the input/output (I/O) system 620 and memory system 630, which may also store information therein in greater or fewer groupings than is shown.

As shown in FIG. 4, the control system 600 determines the barrel 122 pressure in step 202 via inputs received from the pressure switch 108. The control system 600 then compares the barrel 122 pressure to the cut in and cut off values previous described. If the control system 600 determines that the pressure is below the cut off value, the control system 600 signals for the barrel 122 to be filled. To fill the barrel 122, the water valves 124, syrup valves 126, and CO2 valves 128 are opened to allow water, syrup concentrate, and CO2 to simultaneously flow into the barrel 122 together. The water 102 and syrup concentrate 104 in this example are generally kept at a consistent ratio, set by manually adjusting water flow controls 130 and syrup concentrate flow controls 131. For beverage systems known in the art, water valves 124 and syrup valves 126 are controlled in tandem. Depending on the required amount of CO2, the CO2 valve 128 may open fully when the water valves 124 and syrup valves 126 are opened, or may open intermittently, such as via a specified duty cycle.

The water 102, syrup concentrate 104, and CO2 106 pass through the liquid side 132 of an expansion tank 134. The expansion tank 134 is pressurized on the gas side 136 of an internal diaphragm 138, which allows for expansion of the liquid contents of the machine during freezing without damaging the rest of the rigid components within the machine. Liquid product then enters the barrel 122 through a barrel inlet 140 (FIG. 1).

Continuing with reference to FIGS. 2 and 4, the state of the fill process 168 (e.g. the fill process 168A) continues in step 206 (whether filling or not filling) as long as the barrel 122 pressure is between the cut in and cut off values. However, if the pressure in the barrel 122 is determined to be at or above the cut in value in step 208, the water valves 124, syrup valves 126, and CO2 valves 128 are all closed to stop the fill process 168 in step 210.

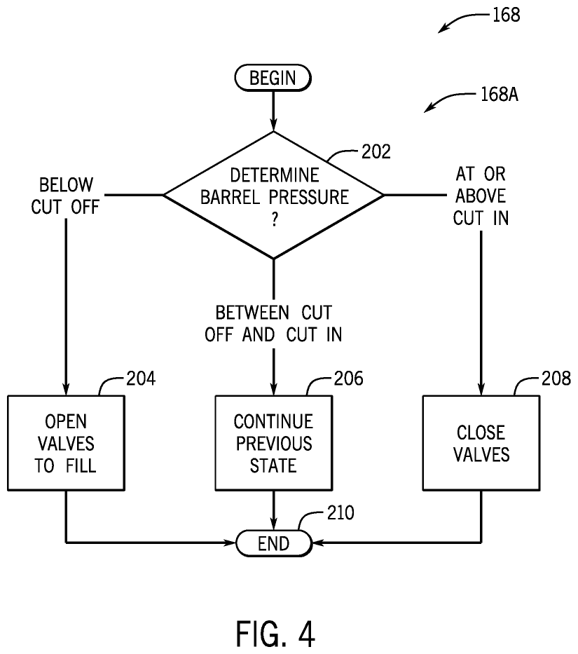

A similar control process occurs with respect to the refrigeration system 101B (FIG. 3), which is shown in the refrigeration process 180 of FIG. 5. In particular, the viscosity of contents in the barrel 122 is used to determine whether the beverage requires more, less, or the same refrigeration at any given time. The viscosity is determined based on the power required by the motor 142, which is read in step 250. The control system 600 (FIG. 6) then determines whether the viscosity falls below a stall value in step 252, based on comparison to a table stored within the data 634 of the memory system 630. If the viscosity is found to be greater than the stall value in step 252, the motor 142 is stopped in step 264 and a defrost process is started to melt the excessive ice causing the excessive viscosity within the barrel 122, ending at step 262.

If alternatively the viscosity is determined in step 252 to be below the stall value, the process continues with determining an action in step 254 based on whether the viscosity is below, above, or between cut in and cut out values (also stored in the data 634 of the memory system 630). If it is determined in step 254 that the viscosity is below the cut in value (meaning low), refrigeration is engaged in step 256, freezing additional content within the barrel 122 to increase the viscosity therein. If alternatively the viscosity is above a stored cut out value, refrigeration is discontinued in step 260 to prevent a further increase in viscosity. Finally, if the viscosity is determined in step 256 to be between the cut in and cut out values, the refrigeration process 180 continues the previous refrigeration step 258 and the process is repeated.

As shown in FIG. 3, the refrigeration system 101B includes a compressor 154 and condenser 156 for the system 100, as well as liquid line solenoid valves 158, hot gas solenoid valves 160, and expansion valves 162 for each barrel evaporator 164. In this manner, the system 100 may supply refrigeration or heat to each barrel 122 independently. In freeze mode, the refrigeration system 101B draws heat out of the barrel 122 through the evaporator until the viscosity of the product meets a specified cut out value, as discussed above. As beverages are dispensed, product is pushed out of the dispense valve 166 (FIG. 1) by pressure within the barrel 122. As the barrel 122 pressure drops below a specified minimum fill pressure, the fill process 168, such as the fill process 168A of FIG. 4, resumes until barrel 122 pressure reaches a specified maximum fill pressure. During the fill process 168, liquid product enters the barrel 122 at ambient temperature through a barrel inlet 140 (FIG. 1). Heat therefore enters the barrel 122 through conduction and friction. As previously stated, the viscosity of the product decreases until it meets a specified cut in value, caused by this heat, until refrigeration begins again.

During the refrigeration process 180 previously discussed, ice crystals form on the inside wall 172 of the barrel 122 (FIG. 1), which are scraped off the inside wall 172 by the scraper blades 146. The inventors have identified through experimentation and research that over time and through multiple refrigeration cycles, the ice crystals in the barrel 122 grow in size and stick together to form larger ice crystals, degrading the smooth texture of the drink produced by the system 100. As the barrel 122 contents rotate, higher density components are driven towards the perimeter of the barrel 122 via centripetal force, likewise forcing lower density components (such as larger ice crystals) towards the center of the barrel 122. This in turn results in larger formations of ice surrounding the beater bar 144, leading to undesired and/or inconsistent product.

After a specified time, the barrel 122 enters a defrost cycle where heat is added to the barrel 122 through the barrel evaporator 164 for a set duration, or until the temperature of the evaporator outlet 178 reaches a specified temperature. In certain examples, the intention of this defrost cycle is to fully melt all product in the barrel 122. From there, the refrigeration process 180 begins again until the viscosity of the product meets a specified cut out value, as discussed with respect to the process flow of FIG. 5.

The inventors have identified that FCB systems presently known in the art are prone to several types of problems. For example, a problem arises when the pressure in a supply line 107 (such as water 102, syrup concentrate 104, CO2 106, and/or others) falls below a specified value. In this case, the dispensing machine 99 in certain systems 100 will disable the fill process 168 to prevent an improper mix of ingredients from entering the barrel 122. Likewise, problems arise when the viscosity of the barrel 122 exceeds a specified safety value intended to prevent damage to the system 100. In this case, the motor 142 is typically disabled and a defrost cycle begins to melt the excess ice that is presumed to be building up within the barrel 122.

The present disclosure further relates to systems and methods for automatically and accurately controlling the brix and CO2 content of product dispensed from a frozen carbonated beverage (FCB) system. In FCB systems known in the art, brix is controlled via an initial configuration process, and periodic adjustments thereafter, to set the flavor and composition mix for the beverage being produced. These periodic adjustments are required due to shifts system performance (and thus flavor) over time, and also as periodic maintenance for the FCB system. This initial configuration and period maintenance requires a skilled technician to perform the process, leading to machine down-time and service costs. Moreover, if settings move out of specification over time, product quality and profitability can be degraded and/or damage to the FCB system may occur. As such, the requirements represent a significant portion of the cost of ownership for FCB systems, and therefore a significant barrier to purchasing these machines.

FCB systems presently known in the art monitor the pressures of water, syrup concentrate, and CO2 supplies to determine if levels are adequate for proper operation. The inventors have identified that when one of these supply lines is depleted, there is often a lag before the pressure drops to the point at which the system identifies the issues and shuts off the flow from that supply line. The inventors have further identified that this lag in response causes the ratio of components within the barrel of the system to deviate from specifications, leading to issues with performance and product quality. For example, when the syrup concentrate of a typical FCB system known in the art becomes depleted, the brix of the mixed product may drop from 13 to 12.5. This drop represents a significant shift in view of the total allowable variance across all operating variables, which may be ±1.0, for example.

Similar issues may arise from the cleaning process of systems presently known in the art. Cleaning an FCB system entails flushing the syrup concentrate lines, and all regions with mixed product, using one or more cleaners and sanitizers. This is then followed by a rinsing process to ensure all cleaners and sanitizers have been flushed out of the system. Due to the arrangement of tubing within the system, the location of the dispense valve, and other factors, residual water remains after this rinsing process within multiple locations of the system. While this residual water may be purged from the system, this involves removing the faceplate of the system to drain water from the barrel, requiring additional time and expense following a cleaning and sanitizing cycle. However, if this manual purging process is not performed, the product after the barrel is refilled will be diluted by this residual water, resulting in a brix reduction of 0.5-1.0 or more.

This sensitivity to changes in supply further demonstrates the importance of accurate and precise operation among the water valve 124, syrup valve 126, and CO2 valve 128. For FCB systems known in the art, this requires greater precision in manufacturing, installation, and setting for these valves. This in turn contributes to increased costs of manufacturing, installation, service, and operation for the system.

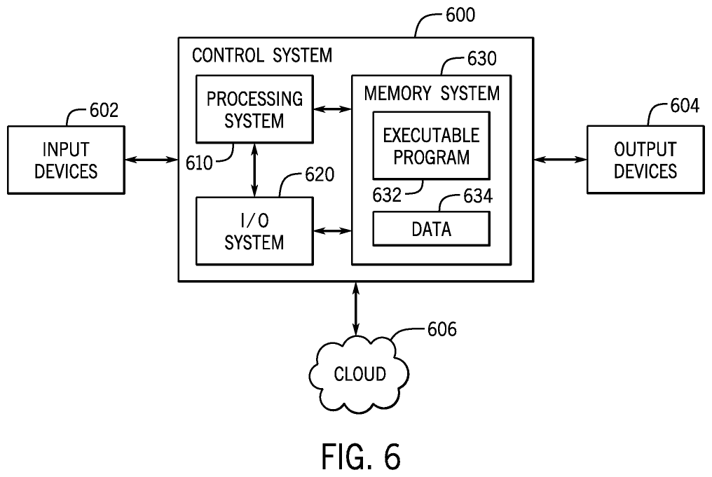

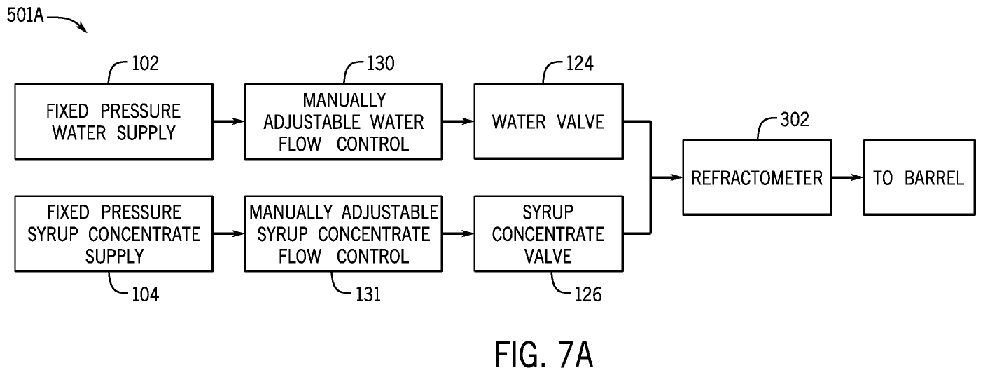

Through research and experimentation, the inventors have developed the presently disclosed systems and methods for automatically controlling brix for FCB products. The system 100 is controlled via a control system 600 (FIG. 6) to provide a target brix for a final beverage. This target brix and other operating parameters may be stored within the data 634 of the control system 600, as previously described. The system 100 measures the brix of the product downstream of the water valve 124, syrup valve 126, water flow control 130, and syrup flow control 131, for example using a digital refractometer 302 (e.g., FIG. 7A). Any exemplary refractometer available commercially is the Gardco CM-BASEa (A). The brix may then be automatically adjusted by the control system 600 varying the relative flow rates of water 102 and the syrup concentrate 104 such that the digital refractometer 302 indicates a brix equal to the target brix (or within an allowable range of target brix values, for example).

In certain embodiments, the control system 600 (FIG. 6) maintains a running average of the brix and controls the system 100 to provide long term stability over real-time accuracy. In particular, the inventors have identified that some real-time variation is acceptable during the fill process 168 because the barrel 122 has a larger volume than the supply lines 107. In this manner, the system 100 detects and compensates for any long-term impacts of momentary variations in brix due to the water 102 or syrup concentrate 104 experiencing an outage, for example, thereby reducing the risk for poor product quality and preventing damage to the system 100. This also allows the system 100 to accommodate for less accurate or less precise components within the system 100, enabling cost reductions for new systems 100, or the maintenance or upgrade of existing systems 100.

Moreover, the systems and methods discussed below also accommodate for the effects of cleaning and sanitation previously described. Specifically, the system 100 may operate via an executable program 632 (FIG. 6) within the control system 600, which is programmed with a benchmark volume of water known to be residual following a cleaning process. This allows the system 100 to compensate for this residual volume following a cleaning cycle to achieve a proper brix in the barrel 122, without the need to manually purge this residual water in the manner described above. This compensation, as an alternative to the manual purging process known in the art, simplifies and accelerates the process for cleaning, while also reducing the corresponding cost.

In addition to controlling the proportions of water 102 (FIG. 2) and syrup concentrate 104, a target CO2 106 content is also controllable by the control system 600 (FIG. 6). The flow of CO2 106 may be controlled by a pressure regulator and orifice in the manner previously described, whereby the flow is further controlled by varying the duty cycle of the CO2 valve 128. In other words, a baseline maximum flow rate occurs with the CO2 valve 128 open, which is reduced by the percentage of time in the duty cycle in which this CO2 valve 128 is closed. This configuration is in contrast to traditionally designed systems, which require a high input pressure to maintain critical flow of CO2 106 for a constant flow rate regardless of the downstream pressure determined to exist within the barrel 122. By monitoring upstream and downstream pressures via the control system 600, a further level of variation to the CO2 valve 128 duty cycle may be introduced to maintain a constant flow despite periods of sub-critical operating conditions.

Exemplary systems and corresponding methods for automatically controlling brix according to the present disclosure are shown in FIGS. 7A-10B. The embodiment shown in FIGS. 7A-7B generally relates to the system and method that include pulsing the water valve 124 and/or syrup valve 126. In this embodiment, fixed pressures are provided for both the water 102 and syrup concentrate 104, whereby each has adjustable flow controls 130 and 131 upstream of the water valve 124 and syrup valve 126, respectively. The corresponding mixture downstream of the flow controls 130 and 131 is then measured using the refractometer 302 en route to the barrel 122. The monitoring and controlling process for this system is shown in FIG. 7B, beginning with reading the brix in step 500, such as through the refractometer 302. The current brix is then read in step 502, averaged over time (such as a running average every 5 seconds, for example), and evaluated versus the target brix in step 502. As discussed above, the target brix may be stored as data 634 within the memory system 630 of the control system 600 and evaluated by the processing system 610 (FIG. 6). If the brix is determined to be too low, step 504 calls for increasing the ratio of syrup valve 126 to water valve 124 duty cycles to correct the brix. In certain systems, the average fill duration (after the initial fill) is approximately 3 seconds. Settings may be adjusted between fill cycles such that each 3 second fill is of a constant setting, whereby any deviation during one fill cycle may be offset in the next.

To better facilitate the accuracy of these adjustments, during initial filling (which may involve 20 seconds or more of filling) the system may run through several steps in adjustment above and below a default starting point to generate a curve of setting vs. brix for the specific syrup. The known duration range of an initial fill should allow this curve generation to be performed with time to bring the barrel average into spec. A further addition would be to measure the temperature of the incoming syrup, and to adjust the curve based on variations in the temperature (as lower temperature will increase the viscosity and higher temperature will lower it). A set of “benchmark curves” may provide a coarse framework for the system to make finer adjustments around. The ability to perform this curve generation, or calibration, to a specific syrup during filling and still result in the correct average brix in the barrel may be unique to this type of product vs. a traditional post-mix dispenser—which mixes immediately prior to dispensing into a cup. Most concepts around automatically setting ratios require a pre-generated curve for the syrup at a specific temperature or require external feedback during setup.

If instead the brix is determined in step 502 to be correct (within the specified range), the ratio of syrup valve 126 to water valve 124 duty cycles is maintained in step 506. Finally, if the brix is determined in step 502 to be too high, the control system 600 calls for decreasing the ratio of syrup valve 126 to water valve 124 duty cycles in step 508. In each case, monitoring remains ongoing and the process repeats at step 500.

The inventors have recognized that controlling the brix by controlling relative duty cycles would not be possible with FCB systems presently known in the art. In particular, systems known in the art provide a fixed upstream pressure and fixed orifice for each of the supply lines. However, the operating pressures of these supply lines is high enough that alternating the duty cycles does not impact the consequent flow of either water 102 or syrup concentrate 104. In other words, the pressures of the supply lines exiting the orifices in systems known in the art is so high that the flow is unaffected by pulsing the supply lines with duty cycles below 100%. For this reason, the systems and methods presently disclosed incorporate the flow controls 130 and 131 upstream of the water valve 124 and syrup valve 126, respectively, as discussed above.

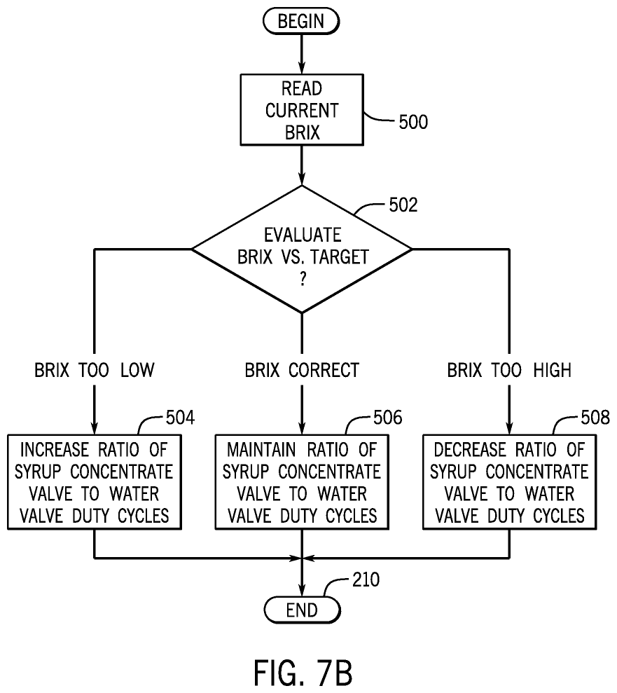

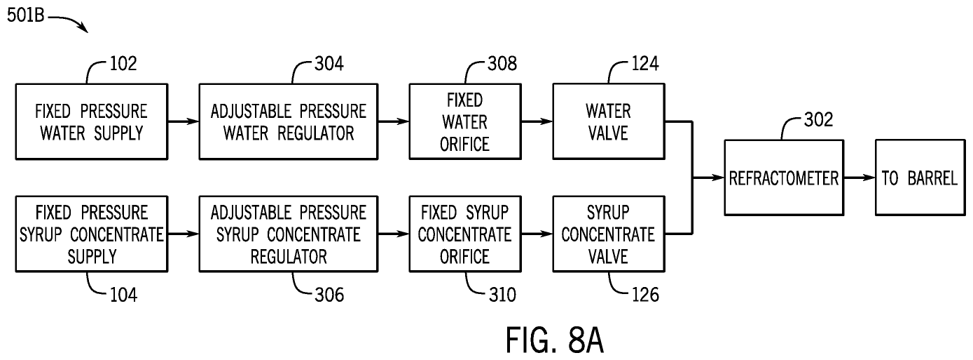

Another exemplary system and corresponding method for automatically controlling brix is shown in FIGS. 8A-8B, which relate to adjusting the pressure of the supply lines for water 102 and/or syrup concentrate 104 to control brix. As shown, the water 102 and syrup concentrate 104 supplies each have a fixed pressure that is subsequently directed through an adjustable regulator 304, 306, respectively. Each supply line 107 then proceeds through a fixed orifice 309, 311 and on to the corresponding water valve 124 and syrup valve 126, respectively. The mixture downstream of the water valve 124 and syrup valve 126 then proceeds to a refractometer 302 in the manner previously described. The corresponding method for automatically controlling brix is shown in FIG. 8B, which begins in the same manner as the method shown in FIG. 7B. In this embodiment, if the brix is determined in step 502 to be too low, the control system 600 in step 514 calls for an increase of the ratio of pressure of the syrup concentrate 104 to the pressure of the water 102, thereby increasing brix. Alternatively, if the brix is determined to be correct in step 502, step 516 is to maintain the ratio of pressures of syrup concentrate 104 to water 102. If brix is determined to be too high then step 518, the control system 600 will decrease the ratio of the pressure of the syrup concentrate 104 to the pressure of the water 102.

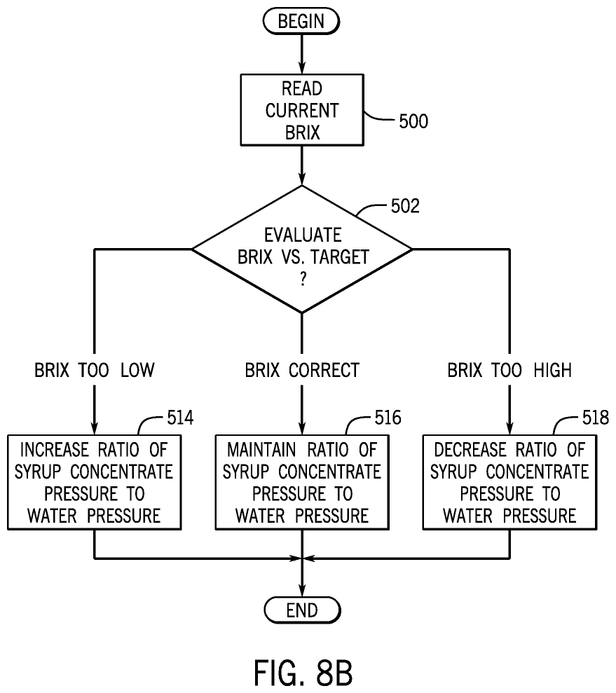

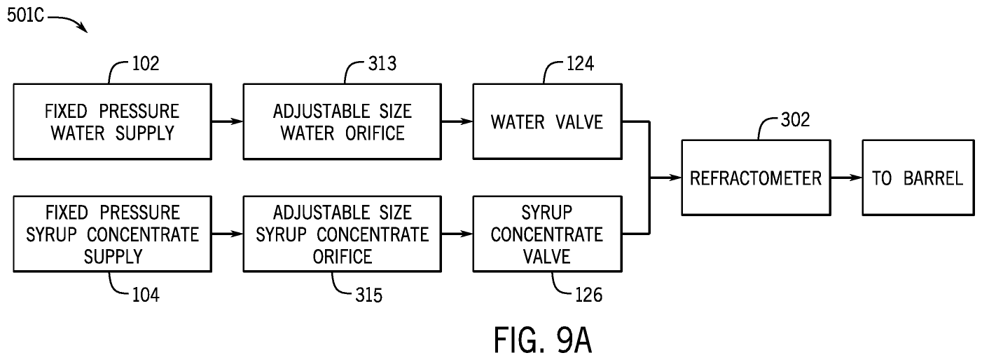

The systems and methods disclosed in FIGS. 9A and 9B, and in 10A and 10B, respectively, relate to systems 100 incorporating either an adjustable orifice or a selectable orifice for controlling brix. In the embodiment of FIG. 9A, fixed pressure water 102 and syrup concentrate 104 supplies are provided, which feed into adjustable orifices 313, 315. These in turn continue to the water valve 124 and syrup valve 126, respectively, whereby the consequent mixture is measured by the refractometer 302 in the manner previously described.

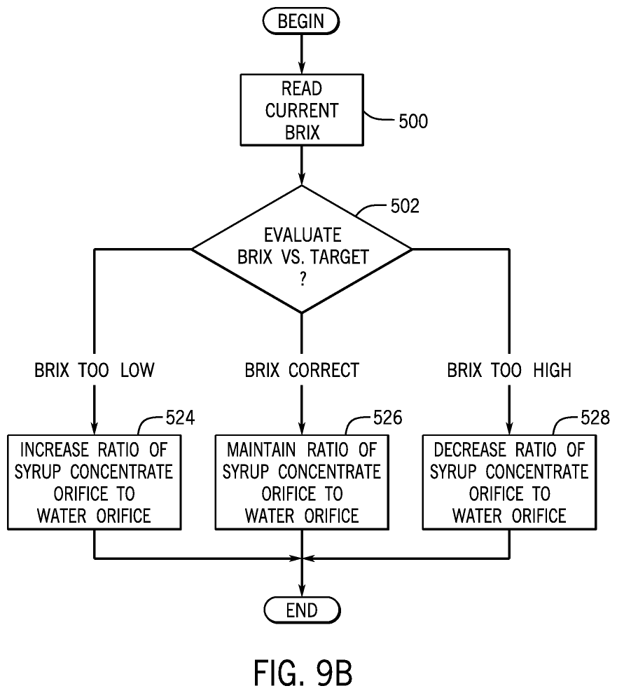

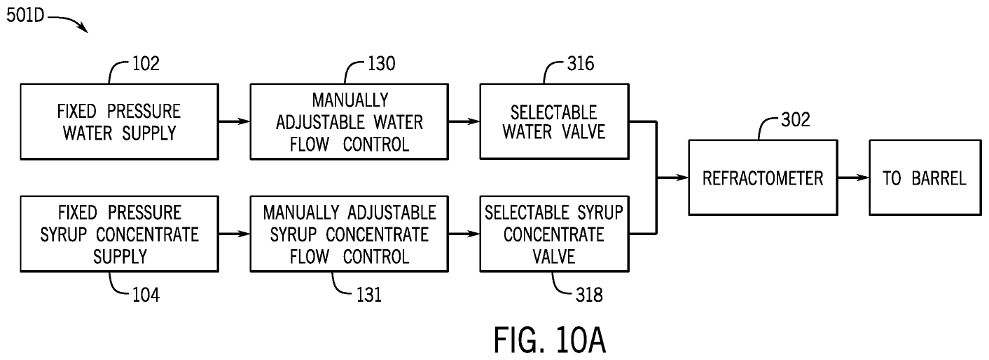

In contrast, the fixed pressure supply provided for both the water 102 and syrup concentrate 104 in the embodiment of FIG. 10A feed in to adjustable flow controls 130, 131, continue to a selectable water valve 316 and a selectable syrup concentrate valve 318, respectively. The mixture downstream of the selectable water valve 316 and the selectable syrup concentrate valve 318 are once again measured with a refractometer 302 in the manner previously described.

Whether adjusting orifice sizes in the embodiment of FIG. 9A, or selecting among orifice sizes in a selectable valve in the embodiment of FIG. 10A, the methods of FIGS. 9B and 10B provide for controlling the system 100 according to similar steps. If the brix is determined to be too low in step 502, steps 524 and 534 call for increasing the ratios of the adjustable orifice for syrup 314 or selectable orifice for syrup 318 to the adjustable orifice for water 312 and selectable orifice for water 316, respectively. In contrast, if the brix is identified as determined to be correct in step 502, the relative ratio of syrup concentrate orifice to water orifice is maintained in steps 526 and 536. If the brix is determined to be too high, the system 100 calls for a decrease in the ratio of the adjustable orifice syrup 314 and selectable orifice for syrup 318 to an adjustable water orifice 313 and selectable water orifice 317, respectively in steps 528 and 538.

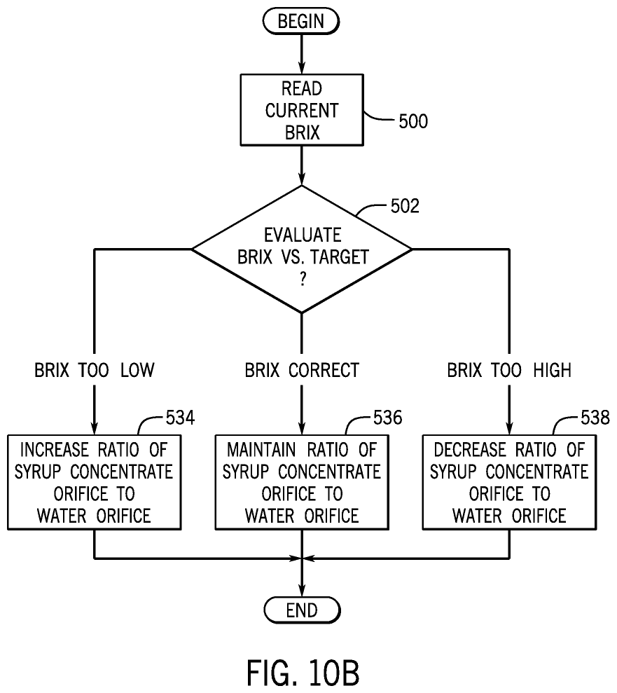

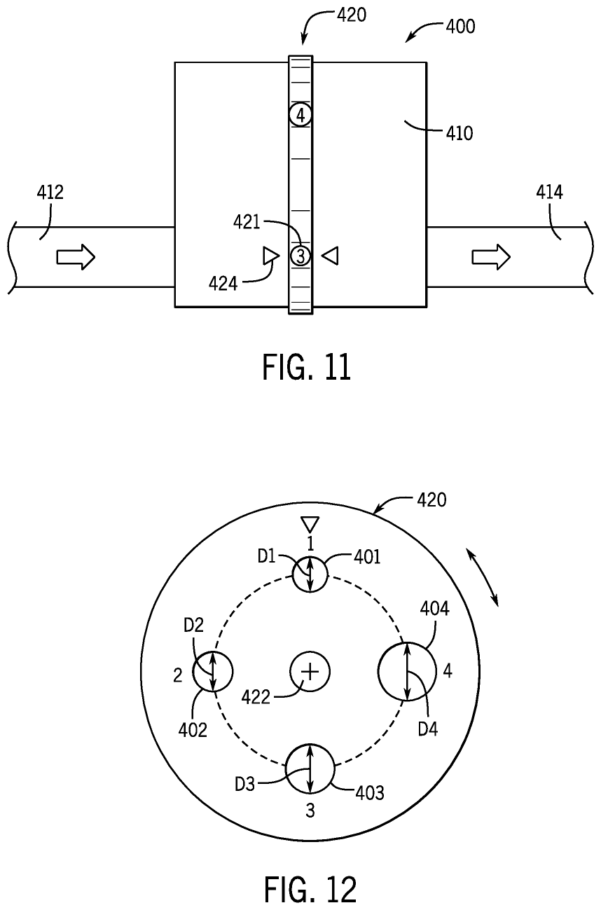

FIGS. 11 and 12 depict an exemplary selectable orifice device 400 usable as the selectable orifice for water 316 and/or the selectable orifice for syrup 318 from FIGS. 10A-10B. As shown, the selectable orifice device 400 has a housing 410 and an internal conduit (not shown) between an inlet 412 and an outlet 414. A selection dial 420 is provided between the inlet 412 and outlet 414 and provides selection of an orifice by aligning a dial marker 421 corresponding to one of the orifice selections with a selection indicator 424. This selection may be manually selectable by a user, and/or mechanically selectable by the control system 600 (such as by a motor, not shown).

As shown in FIG. 12, the selection dial 420 rotates about an axle 422 and defines orifices 1-4 401-404 available for selection. The orifices 1-4 401-404 have corresponding diameters D1-D4, providing for different flows therethrough as the corresponding supply line 107 flows between the inlet 412 and the outlet 414 of the selectable orifice device 400. In this manner, the orifices 1-4 401-404 are selectable as part of an initial setup, perhaps depending upon characteristics of a particular beverage being produced within the barrel 122, or may be adjustable in response to changes in performance of the system 100 over time.

The present disclosure further relates to systems and methods for improving the consistency of dispensed frozen beverages, as well as improved reliability of frozen carbonated beverage (FCB) systems 100 (see FIG. 1). In FCB systems presently known in the art, the contents within the barrel are periodically melted and re-frozen to preserve the quality of drink consistency therein. Through research and experimentation, the inventor has identified that the contents within the barrel shrink and expand considerably during this melting and freezing process. Moreover, since these systems are sealed, the internal pressure of the system may vary significantly as well.

The exemplary system 100 of FIG. 1 includes an expansion tank 134 (FIG. 3) that contains product within an internal diaphragm 138 on a liquid side 132 of the expansion tank 134, and pressurized gas (typically CO2 106) on an opposite gas side 136. This allows for expansion during the normal freezing process. However, the inventors have identified that this expansion tank 134 alone may not adequately compensate for significant changes in all states or modes of operation for the system 100.

Through research and experimentation, the inventors have also identified that during a defrost cycle, the pressure within the system drops below the pressures (the cut off pressure) that would typically trigger refilling of the barrel. In certain systems known in the art, the fill process remains enabled during the defrost cycle, resulting in a barrel that exits the defrost cycle with more product than when the barrel entered the defrost cycle. In other words, the barrel is filled due to a temporary drop in pressure, even though no product has been dispensed. This in turn leads to excessive pressure in the barrel once the content is fully frozen again (to achieve the desired viscosity, as discussed above). The inventor has further identified that this also leads to the product being dispensed with lower overrun than desired, causing customer dissatisfaction and reduced revenue since lower overrun equates to more syrup within a given drink. In brief, “overrun” is known in the industry as the amount of product volume attributable to CO2, rather than the water and syrup concentrate. In this manner, low overrun means less CO2 than desired, meaning a higher ratio of the other constituents.

Alternatively, some systems known in the art instead disable the fill process during the defrost cycle to prevent this overfilling. In this case, the barrel exits the defrost cycle with the same volume of contents as when the defrost cycle began. However, the inventor has identified that disabling the fill process can also create problems. Specifically, if a drink is dispensed during while the fill process is disabled, the pressure within the barrel can drop to 0 psig, which can be reduced even further (below 0 psig) as the product within the barrel subsequently melts. This reduction below 0 psig stresses sealing components, causing leaks and damage to the system.

A similar condition can occur when one of the supply lines (i.e., water, syrup concentrate, or CO2) drops below the specified supply pressure while. Specifically, systems known in the art disable the fill process when a supply line is out to avoid filling the barrel with an incorrect ratio of components. In this situation, the inventor has identified that if supplies are not replenished quickly, the contents of the barrel can melt, leading to the same problems with 0 psig or negative pressure in the barrel previously discussed.

In certain systems known in the art, an indicator is provided (such as a light or a display message on a user interface) to inform users that product should not be dispensed. For the reasons provided above, this indicator would be activated during a defrost cycle or when one or more supplies are recognized as being “sold out”. However, the inventor has identified that this indicator is frequently ignored by users, who attempt to dispense drinks regardless of the indicator.

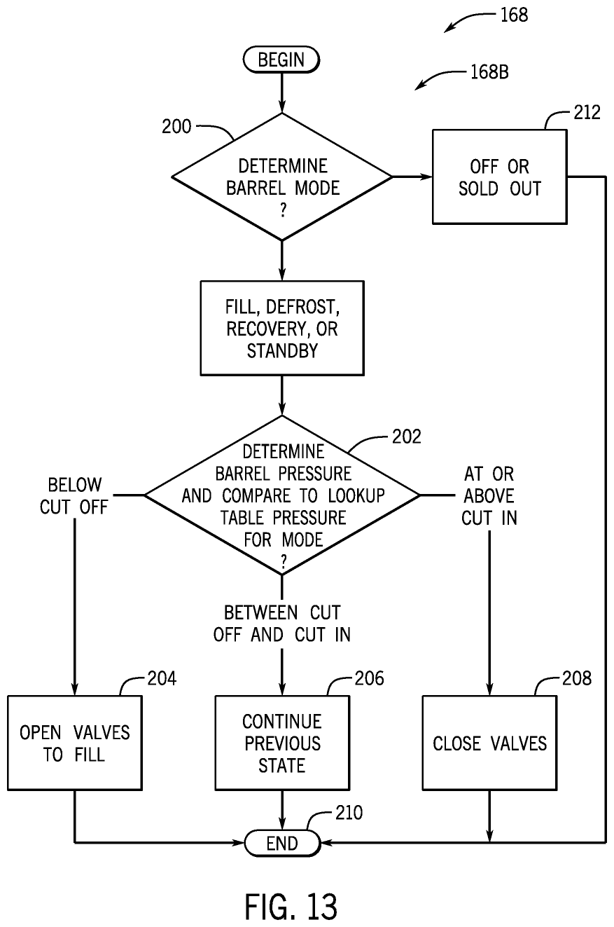

FIGS. 13-14 and 17-18 depict additional fill processes 168 incorporating additional fill logic according to the present disclosure. In certain embodiments, the presently disclosed systems and methods provide for fill processes 168 in which the cut in and cut out pressures vary based on the machine state or machine mode: filling, defrosting, recovering (the time for the content to return to acceptable viscosity), and standby mode, for example. The cut in pressure represents the low end of a target pressure range, and the cut out pressure represents the high end, as previously discussed. In certain examples, the cut in and cut out pressures are stored within the data 634 of the memory system 630 for the control system 600 (FIG. 6). In this manner, the fill processes 168 provides for filling the barrel 122 when the pressure is below the cut in pressure, and continuing to fill the pressure until it reaches the cut out pressure (see FIG. 4).

The filling process 168B of FIG. 13 begins with determining a barrel mode or machine state in step 200, such as filling, in a defrost cycle, in recovery, or in standby mode, or alternatively the system being in an off or sold out state. If the machine is determined to be filling, in a defrost cycle, recovery, or standby in step 200, the method continues to step 202, which determines the pressure of the barrel 122 and compares this pressure to pressures in a lookup table 635 corresponding to the mode determined in step 200. In the same manner as previously described, the lookup table 635 pressures for each corresponding mode may be stored as data 634 within the memory system 630 (FIG. 6).

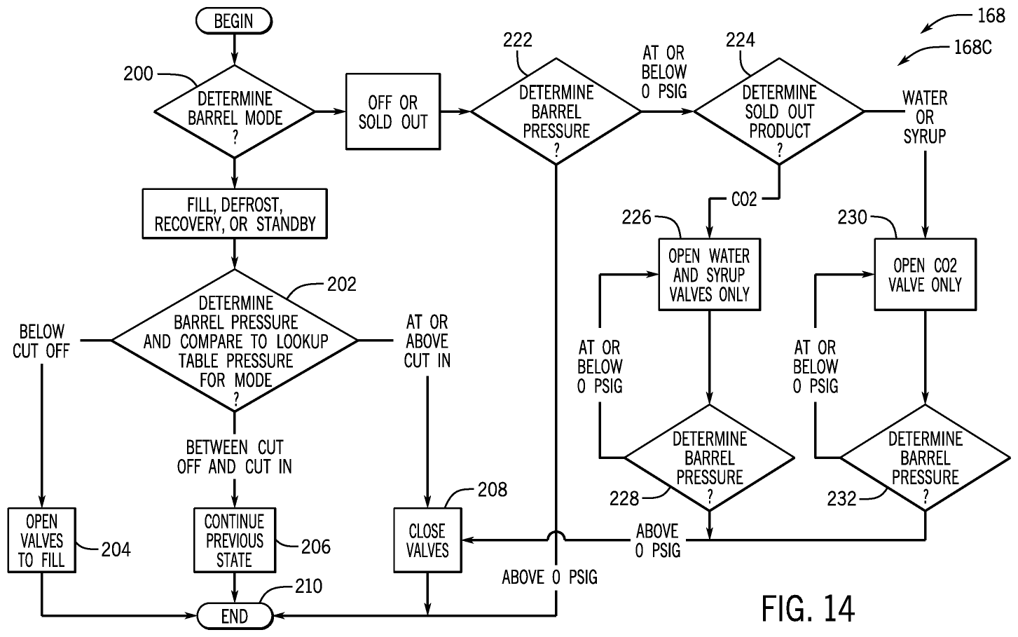

In this manner, the pressure of the barrel 122 is monitored during operation. In certain examples, the fill process 168B for normal operation of the barrel 122, for example in standby mode, calls for maintaining a standard pressure within the barrel 122 of 23-28 psig, for example. When the system 100 enters a defrost cycle, the pressure range for the fill process 168B is lowered to a defrost pressure that in this case is below the standard pressures, for example 3-5 psig. In other words, by lowering the cut in and cut out pressure during the defrost cycle, erroneous filling of the barrel 122 is avoided. In further embodiments, such as the exemplary filling process 168C of FIG. 14, an exception is made whereby filling is nonetheless permitted if there is risk of the barrel 122 dropping below 0 psig. In this manner, the processes shown in FIGS. 7-8 limit the pressure inside the barrel 122 to those typically observed during a normal defrost cycle, which ensures that when the product re-freezes, the barrel 122 will remain within the standard range associate with normal operation in standby mode (e.g., 23-28 psig).

As also shown in FIGS. 13-14, if the pressure in the barrel 122 is determined in step 202 to be below the cut out pressure listed in the lookup table stored as data 634 in the memory system 630, step 204 provides that one or more valves are opened to fill the barrel 122 in the manner previously described. If instead the pressure in the barrel 122 is determined to be between the cut in and cut out pressures corresponding to the lookup table pressures for the given mode identified in step 200, the system 100 will continue the existing state with respect to valve positions in step 206, ending the process at step 210. Alternatively, if the barrel 122 is determined to have a pressure that is at or above the cut in pressure of the lookup table 635 stored as data 634, step 208 calls for the valves feeding the barrel 122 to be closed, also ending the process at step 210.

In the embodiment of FIG. 13, if at step 200 it is determined that the barrel 122 is in an off or sold out state, the fill process 168B ends the process at step 210. If instead this is determined within the fill process 168C of FIG. 14 (providing negative pressure protection for the barrel 122), the process continues with step 222, determining the pressure within the barrel 122. If it is determined that the pressure in the barrel 122 is at or below 0 psig, step 224 then determines which supply line 107 (FIG. 2) is sold out. If it is determined that the CO2 106 supply is sold out, step 226 provides that the water valve 124 (FIG. 2) and syrup valve 126 are opened to increase the pressure in the barrel 122 above 0 psig to prevent leaks as previously discussed. The process then continues with the determination and monitoring of pressure in the barrel 122 in step 228, which repeats the process until the pressure in the barrel 122 is above 0 psig, at which point the valves are closed in step 308 to end the process in step 310.

If instead in step 224 it is determined that water 102 or syrup concentrate 104 is the sold out product, the CO2 valve 128 (FIG. 2) is opened at step 230 until it is determined in step 232 that the pressure in the barrel 122 becomes above 0 psig, at which point the valves are closed at step 208 completing the process in step 210.

In this manner, when the system 100 enters a “sold out” state, pressure in the barrel 122 is monitored and maintained above 0 psig by allowing the ratios of water 102, syrup concentrate 104, and CO2 106 to deviate from a preferred level in order to prevent damage to the system 100. If water 102 or syrup concentrate 104 is sold out, the addition of CO2 106 to maintain a positive barrel 122 pressure (while resulting in higher overrun and “sputtering” drinks), is preferable to a system leak. Likewise, if CO2 106 is sold out, water 102 and syrup concentrate 104 can be filled to maintain a positive barrel 122 pressure, which although resulting in lower overrun is also preferable to a system 100 leak. In certain embodiments, limits are placed either with respect to the time or volume for filling the barrel 122 in an effort to maintain positive barrel 122 pressure.

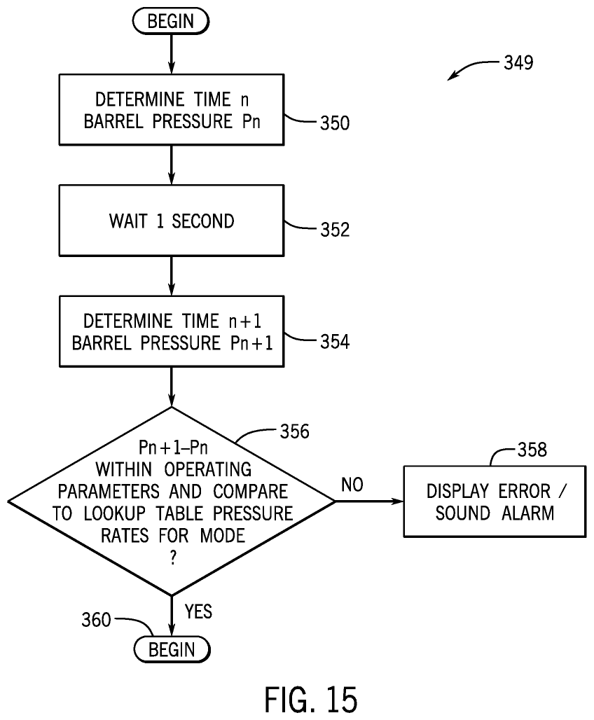

FIG. 15 depicts an exemplary detection process 349 according to the present disclosure for detecting an undesired dispensing of beverages from the barrel 122. As discussed above, dispensing of contents from the barrel 122 during the defrost cycle or other inappropriate times can lead to the reduction of pressure in the barrel 122 below 0 psig and consequent leaks or damage. The detection process 349 depicted in FIG. 15 assists in preventing this undesired dispensing. In particular, when a system 100 is in a defrost cycle or sold out state, the inventor has identified that it is possible to detect the dispensing of a drink by observing that the pressure in the barrel 122 drops faster than anticipated for that defrost cycle or sold out state.

Through experimentation and development, the inventors have identified normal expectations for the changes in barrel 122 pressure during each state of the system 100, which may be stored as data 634 in the memory system 630 of the control system 600 (FIG. 6). For example, FIG. 15 provides for determining the barrel 122 pressure at a given time in step 350, waiting one or more seconds (or another appropriate interval) in step 352, and then determining a subsequent barrel 122 pressure for a subsequent time in step 354.

The change between the pressure determined at step 354 versus the pressure taken at step 350 is then compared in step 356 to lookup table 635 pressure rates stored for each mode, which are stored as data 634 in the memory system 630 of the control system 600 (FIG. 6). If the changing pressure is determined in step 356 to not be within standard operating parameters, a further error or sound alarm may be generated in step 358, such as flashing an indicator on the system 100 and/or generating a louder or more obvious alarm to prevent further dispensing of the beverage by a customer operator of the system 100. If alternatively, it is determined in step 356 that the change in pressure is within operating parameters, the process ends at step 360 and pressure monitoring continues. Further alerts may also be sent to the operator of the dispensing machine 99, such as via communication with the cloud 606 (FIG. 6).

Additional complexity is introduced when accommodating for the effects that a sanitation or cleaning cycle have on the brix for subsequent beverages. During sanitizing of the system, which may vary from daily to yearly depending on product dispensed, the system is flushed with cleaning and/or sanitizing agents and then rinsed. The resulting condition is a sanitized barrel with some volume of clean water below the valve outlet. During a flavor change, the system may be flushed without sanitizing, with the end resulting condition the same. This residual water cannot be removed without opening the barrel faceplate and potentially introducing contaminants. Further, removing the faceplate requires additional technical skill and may reduce the ability of general store employees from sanitizing or replacing flavors.

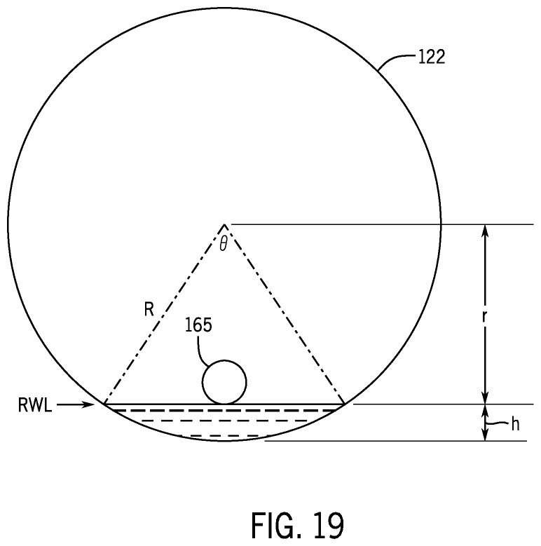

The post-cleaning condition is demonstrated in FIG. 19. As shown, there is a residual water level RWL of rinsing water that remains below the outlet 165, and thus cannot be drained without removing the faceplate. To account for this residual water level RWL, the volume of the remaining water v is calculated as the length of the barrel L multiplied by the cross sectional area of the water:

$$v = L \times ( {R}^{2} {cos}^{- 1} ( \frac{R - h}{R} ) - ( R - h ) \sqrt{2 Rh - {h}^{2}} )$$

The volume of syrup V required to mix to the target brix can be calculated:

$$B = \frac{SV}{V + v}$$

$$V = - \frac{Bv}{B - S}$$

The equivalent fill time for this volume of syrup is calculated by dividing by the flow rate of Syrup F. Fill time will be varied by pressures and temperatures similarly to the normal fill process, with the focus on controlling total volume of syrup vs. ratio. Once the correct volume of syrup is filled into the barrel, the normal fill process will resume.

The inventors have identified further benefits over FCB systems presently known in the art through the combination of different processes and features previously described above. For example, further precision and accuracy can be attained in automatically controlling an FCB system during a fill process to achieve the desired target brix of the beverage within the barrel, such as through the recognition that different conditions within one or more of the supply lines 107 and/or the barrel 122 can impact the consequent brix of a beverage created within the barrel 122 relative to assumptions made for nominal conditions. These current conditions include pressures and/or temperatures within the supply lines 107 and/or barrel 122, which can impact flow rates and the amount of expansion expected within the barrel 122 when the system is at a fully frozen state.

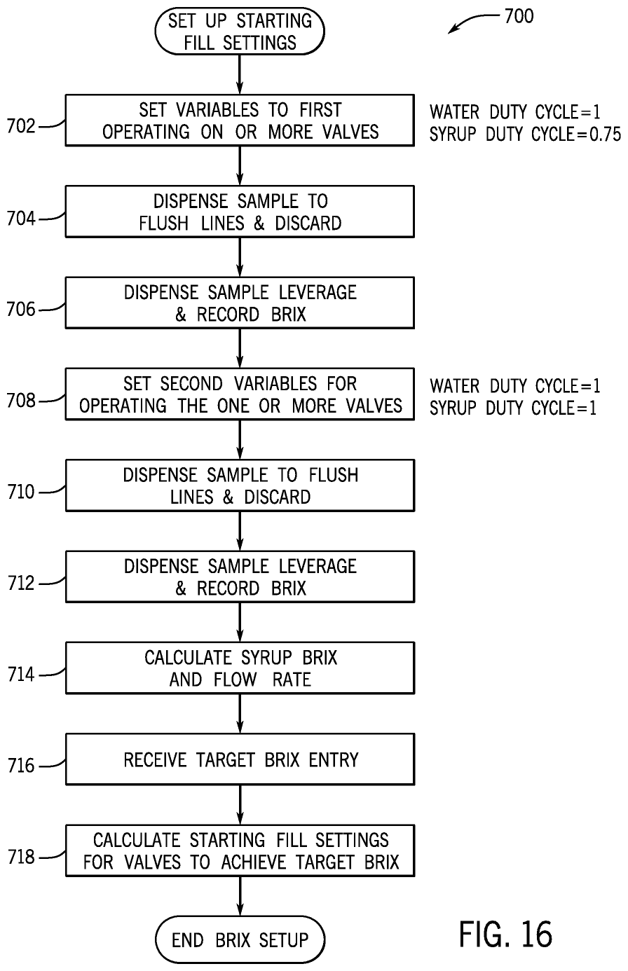

In certain embodiments, this optimized process begins with setting up starting fill settings for the supply lines as provided in the brix setup process 700 depicted in FIG. 16. The process begins at step 702, which sets first variables for operating one or more valves corresponding to the supply lines 107. In the present example, the first variables correspond to water 102 and syrup concentrate 104 lines, and particularly a water duty cycle=1 relative to a syrup duty cycle=0.75. However, it should be recognized that the variables provided herein are merely exemplary. Next, a portion of beverage is dispensed to the flush lines in step 704, and subsequently discarded. A sample beverage is then dispensed in step 706, whereby the corresponding brix associated therewith is recorded, for example using a distal refractometer 302 as previously discussed.

Next, second variables for operating the one or more valves corresponding to the supply lines 107 are set in step 708, in the present example a water duty cycle remaining=1, but with an adjusted syrup duty cycle now also=1. As with step 704, a portion is dispensed and discarded in step 710, following a sample beverage dispense in step 712, whereby the brix of the sample is corresponding recorded. The brix and corresponding flow rates are then calculated in step 714, for example using the variables and equations provided below;

Variables:

B=Beverage Brix (measurable)

S=Syrup/Concentrate Brix (calculable)

w=Water/Base Brix (set to 0)

F=Syrup/Concentrate Flow Rate (calculable)

f=Water/Base Flow Rate (nominally set to 1.6)

D=Syrup/Concentrate Duty Cycle (controllable)

d=Water/Base Duty Cycle (controllable)

t′=Temperature at Setup

Pw′=Water/Base Pressure drop at Setup

Ps'=Syrup/Concentrate Pressure drop at Setup

Primary Equations

$$B = \frac{SFD + wfd}{FD + fd}$$

$$B = \frac{SFD}{FD + fd}$$

Solving for S

$$S = \frac{B ( DF + df ) - dfw}{DF}$$

For w=0

$$S = \frac{B ( DF + df )}{DF}$$

For Brix setup (Determining starting fill settings), f=1.6, d=1

$$S = \frac{B ( DF + 1.6 )}{DF}$$

For Brix Sample A, Set D=0.75 and record drink Brix B_{.75}

$$S = \frac{{B}_{.75} ( .75 F + 1.6 )}{.75 F}$$

For Brix Sample B, Set D=1 and record drink Brix B₁

$$S = \frac{{B}_{1} ( F + 1.6 )}{F}$$

Solve for F

$$\frac{{B}_{.75} ( .75 F + 1.6 )}{.75 F} = \frac{{B}_{1} ( F + 1.6 )}{F}$$

$$F = - \frac{1.6 {B}_{.75} - 1.2 {B}_{1}}{.75 ( {B}_{.75} - {B}_{1} )}$$

Solve for S

$$S = \frac{{B}_{1} ( - \frac{1.6 {B}_{.75} - 1.2 {B}_{1}}{.75 ( {B}_{.75} - {B}_{1} )} + 1.6 )}{- \frac{1.6 {B}_{.75} - 1.2 {B}_{1}}{.75 ( {B}_{.75} - {B}_{1} )}}$$

$$S = - \frac{{B}_{1} ( - \frac{1.6 {B}_{.75} - 1.2 {B}_{1}}{.75 ( {B}_{.75} - {B}_{1} )} + 1.6 ) \times .75 ( {B}_{.75} - {B}_{1} )}{1.6 {B}_{.75} - 1.2 {B}_{1}}$$

All variables are now known, and can be used to determine target syrup and water duty cycles to achieve target drink brix.

Additional complexity may be introduced to real-world applications by variations in system pressures and temperatures. Setup temperature t′ and pressure P′ can be automatically recorded from sensors to allow adjustment as conditions change.

In the case of pressures, flow rates f and F may be altered by variations in pressure drop across the orifice, for example. The impact of the pressure differential may be calculated or determined by lookup table 635 with values derived from representative sample syrups, or other concentrates for example.

In the case of temperatures, the viscosity of syrups is impacted by temperature, with higher temperatures leading to lower viscosities. Therefore, higher temperatures will result in higher flow rates through an orifice for a given pressure differential. Impact of temperature variations can be approximated based on a lookup table with values derived from representative sample syrups (i.e. one set of curves for “standard” FCB syrups, another for “standard” fountain syrups, another for “diet” FCB syrups, and another for “diet” fountain syrups).

Thus, the flow rate f may vary based on pressures and the flow rate F may vary based on both pressures and temperatures. If pressures and temperature are recorded during initial brixing, adjustments can be made as conditions change.

During a fill condition, the predicted brix with both syrup and water valves at 100% duty cycle is calculated and compared to the target brix. If the predicted brix is higher than target, the syrup valve will be pulsed to reduce syrup flow and decrease brix. If the predicted brix is lower than target, the water valve will be pulsed to reduce water flow and increase brix.

In either case, the basic equation for brix will be solved for the duty cycle to be calculated:

$$B = \frac{SFD}{FD + fd}$$

Solving for Syrup Valve Duty Cycle D:

$$D = - \frac{Bfd}{F ( B - S )}$$

Alternately solving for Water Valve Duty Cycle d:

$$d = \frac{DSF - BDF}{Bf}$$

From here, a target brix entry for the final beverage to be produced in the barrel 122 is received in step 716, which can be plugged into the equations provided above to calculate starting fill settings for the valves corresponding to supply lines 107 to achieve this target brix in step 718.

Using these equations, further adjustments can then be made to the starting fill settings previously determined to accommodate for pressure, temperature, and other current conditions of the supply lines 107 and/or barrel 122 to accommodate for these current conditions and nonetheless achieve the target brix within the barrel 122. These current conditions may be read using conventional sensing devices commercially available and known in the art.

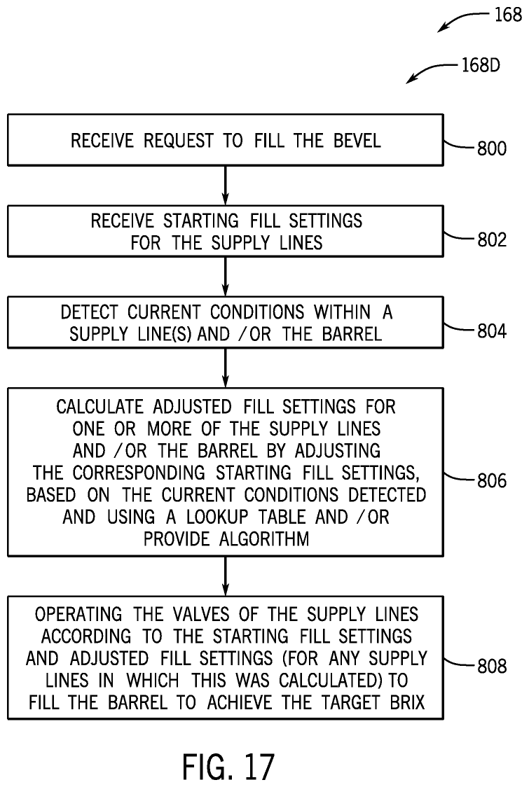

In the exemplary fill process 168D of FIG. 17, a request to fill the barrel 122 is received in step 800. The fill process 168D then receives the starting fill settings for the supply lines 107 in step 802, which as previously discussed may be derived following the brix setup 700 of FIG. 16, for example. The fill process 168D then detects current conditions within one or more of the supply lines 107, and/or within the barrel 122. As discussed above, these current conditions may include pressures, temperatures, or other properties having an impact on the flow rate, composition, or other material properties corresponding to the fluids and/or gases within the supply lines 107 and/or barrel 122.

Next, adjusted fill settings are calculated in step 806 for one or more of the supply lines 107 and/or the barrel 122, specifically by adjusting the corresponding starting fill settings based on the current conditions detected in step 804. These adjustments and calculations may be provided using a lookup table 635, such as previously discussed, and/or through the use of provided algorithms.

Once adjusted, the valves corresponding to the supply lines 107 are operated according to their starting fill settings, or their adjusted fill settings for any supply lines 107 in which adjusted fill settings were determined in step 806. By operating the valves in this manner, the supply of components into the barrel 122 are fine-tuned to achieve the target brix notwithstanding the impacts of the current conditions detected in step 804 on the corresponding supply lines 107.

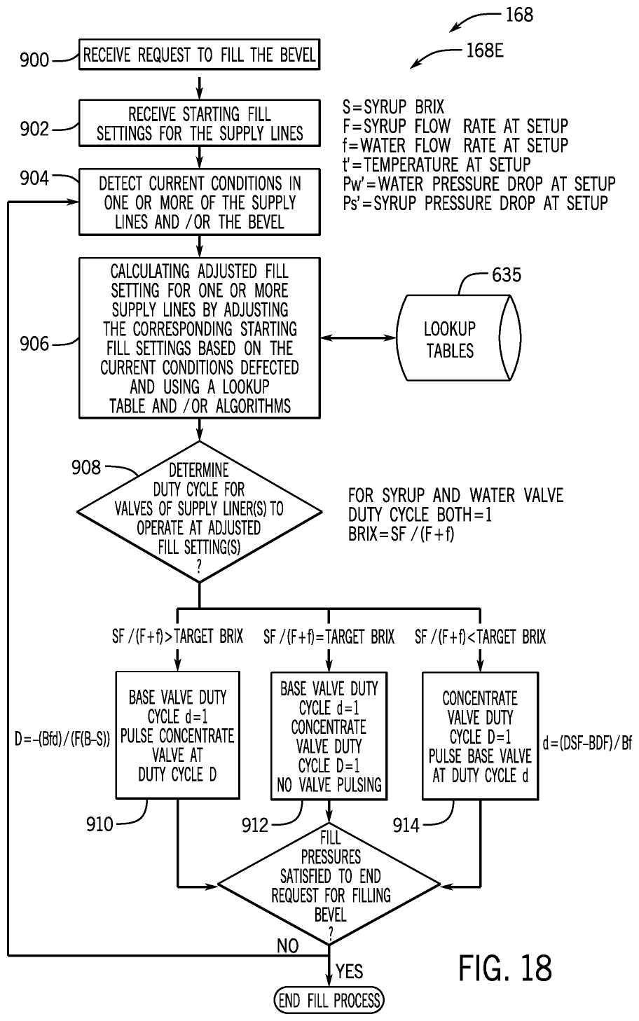

Another exemplary fill process 168E is provided in FIG. 18. The fill process 168E begins similarly to that of fill process 168D of FIG. 17, beginning with receiving a request to fill the barrel 122 in step 900, as well as receiving starting fill settings for the supply lines 107 in step 902. The current conditions in one or more of the supply lines 107 and/or the barrel 122 are detected in step 904, whereby in step 906 adjusted fill settings are calculated for the one or more supply lines 107 by adjusting the starting fill settings based on the current conditions detected in step 904, and using a lookup table 635 and/or algorithms.

In the fill process 168E of FIG. 18, the adjusted fill settings are particularly made with respect to varying the duty cycle for the valves of the supply lines 107, which are determined in step 908. In conditions in which the calculated brix is greater than the target brix, step 910 provides for the base valve duty cycle to be equal to 1, and to pulse the concentrate valve at a duty cycle of D according to the equations provided above. In other words, since the target brix is presently exceeded, the concentrate valve is pulsed such that more water (or base) is provided to the barrel 122 than concentrate, for example.

If instead it is determined in step 908 that the calculated brix is equal to target brix, both the base valve and the concentrate valve are operated at a duty cycle equal to 1 in step 912, or in other words no valve pulsing is required.

Alternatively, if the calculated brix is found in step 908 to be less than the target brix, the concentrate valve is operated at a duty cycle of 1 in step 914, and the base valve is pulsed at a duty cycle equal to d in accordance with the equations provided above. In other words, step 914 provides a substantially opposite effect of step 910.

The fill process 168E continues with step 916, which determines whether fill pressures have been satisfied within the barrel 122 to end the request for filling the barrel, for example using a conventionally known logical process as discussed above. If not, the process returns to step 904 until such time that the fill pressures are satisfied, which ends the fill process 168E.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

We claim:

1. A method for filling a barrel of a frozen beverage dispenser to create a beverage, the method comprising:
determining a target brix level for the beverage;
determining a starting fill setting for a supply line that fills the barrel;
detecting a current condition within at least one of the supply line and the barrel;
calculating an adjusted fill setting by adjusting the starting fill setting for the supply line based on the current condition detected; and
operating the supply line at the adjusted fill setting to fill the barrel such that the target brix level is achieved within the barrel.

2. The method according to claim 1, wherein the current condition includes a pressure.

3. The method according to claim 1, wherein the current condition includes a temperature.

4. The method according to claim 1, wherein the current condition is detected for both the supply line and the barrel.

5. The method according to claim 1, wherein the supply line is two or more supply lines, and wherein the adjusted fill setting is determined for each of the two or more supply lines.

6. The method according to claim 1, further comprising detecting with a detector an actual brix level within the barrel.

7. The method according to claim 1, wherein the starting fill setting and the adjusted fill setting each include a flow rate.

8. The method according to claim 1, wherein the starting fill setting and the adjusted fill setting each include a duty cycle.

9. The method according to claim 1, wherein the starting fill setting is determined by comparing measurements of an actual brix level when the supply line is operated at a first setting and at a second setting.

10. The method according to claim 9, wherein the supply line is a concentrate supply line, further comprising a base supply line that also fills the barrel according to base fill settings, wherein the base fill settings remain unchanged when the concentrated supply line is operated at the first setting and at the second setting.

11. The method according to claim 10, wherein a duty cycle for the base supply line at the base fill setting is one, a duty cycle for the concentrate supply line at the first setting is 0.75, and the duty cycle for the concentrate supply line at the second setting is 1.0.

12. The method according to claim 1, wherein the adjusting of the starting fill setting is performed using a lookup table based on the current condition detected.

13. A frozen beverage dispenser having a barrel configured to be filled with a beverage, the frozen beverage dispenser comprising:
a concentrate supply line controllable by a concentrate valve to fill the barrel with a concentrate;
a base supply line controllable by a base valve to fill the barrel with a base liquid;
a target brix level provided for the beverage in the barrel;
starting fill settings for operating the concentrate valve and the base valve;
one or more sensors that detect a current condition within at least one of the concentrate supply line, the base supply line, and the barrel;
a control system that receives the current condition and calculates an adjusted fill setting for operating at least one of the concentrate valve and the base valve based on the current condition detected; and
wherein the at least one of the concentrated valve and the base valve are operated according to the adjusted fill setting to fill the barrel such that the target brix level is achieved within the barrel.

14. The system according to claim 13, wherein the concentrated valve is operated according to the adjusted fill setting and the base valve is operated according to the base valve thereof.

15. The system according to claim 13, wherein the current condition includes a pressure and a temperature.

16. The system according to claim 13, wherein the current condition is detected for the barrel, the concentrate supply line, and the base supply line.

17. The system according to claim 13, wherein the starting fill setting and the adjusted fill setting each include a duty cycle.

18. The system according to claim 13, further comprising a brix sensor that detects an actual brix level within the barrel, wherein the starting fill settings are determined by comparing measurements of the actual brix level when the concentrated supply line is operated at a first setting and at a second setting.

19. The system according to claim 13, further comprising a memory system that stores a lookup table, wherein the control system adjusts the starting fill settings using the lookup based on the current condition detected.

20. A method for filling a barrel of a frozen carbonated beverage dispenser to create a beverage, the method comprising:
determining a target brix level for the beverage;
determining starting fill settings for supply lines that fill the barrel, wherein the supply lines include a concentrate supply line, a carbonation supply line, and a base supply line that fill the barrel via a concentrate valve, carbonation valve, and a base valve, respectively;
detecting current conditions within each of the supply lines and the barrel, wherein the current conditions include a pressure and a temperature;
calculating one or more adjusted fill settings by adjusting one or more of the starting fill settings, based on the current conditions detected and using a lookup table; and
operating the supply lines at the base fill settings and the one or more adjusted fill settings, respectively, to fill the barrel such that the target brix level is achieved within the barrel.
